(19) United States
(12) Patent Application Publication
(10) Pub. No.: US 2023/0138551 A1
(43) Pub. Date: May 4, 2023

(54) GREEN BUILDING SYSTEM AND METHOD

(71) Applicant: Ekotrope Inc., Boston, MA (US)

(72) Inventors: Edward F. CRAWLEY, Cambridge, MA (US); Cy HOADLEY KILBOURN, Boston, MA (US); Ziv ROZENBLUM, Chestnut Hill, MA (US); Amos BENNINGA, Lexington, MA (US); Nick SISLER, Boston, MA (US); Blake BISSON, Pepperell, MA (US)

(21) Appl. No.: 17/856,047

(22) Filed: Jul. 1, 2022

Related U.S. Application Data
(63) Continuation of application No. 13/678,456, filed on Nov. 15, 2012, now abandoned.
(60) Provisional application No. 61/560,284, filed on Nov. 15, 2011.

(51) Int. Cl. G06Q 10/0631; G06Q 50/08

(52) U.S. Cl. CPC G06Q 10/06313; G06Q 50/08

(57) ABSTRACT

A green building materials system and method are provided in which a decision engine determines one or more designs (each have one or more building components) based on a set of building related inputs and a utility function of each particular user.

### PRIORITY CLAIMS/RELATED APPLICATIONS

This application is a continuation of U.S. patent application Ser. No. 13/678,456, filed on Nov. 15, 2012, which claims the benefits under 35 U.S.C. 119(e) and 120 to U.S. Provisional Patent Application Ser. No. 61/560,284 filed on Nov. 15, 2011 and entitled “Green Building System and Method”, the entirety of which is incorporated herein by reference.

### FIELD

The disclosure relates generally to a system and method for determining building components.

### BACKGROUND

The building of energy efficient buildings (known as green building) has become a very popular task. The demand for building of energy efficient buildings has accelerated recently due to various factors including widespread regulations, tax and cash incentives, availability of cost-effective energy-efficient solutions, expected energy cost growth, an overall desire to be more environmentally responsible and/or energy related comfort that is important to people with low price sensitivity.

Meeting environmental construction goals (for example—reducing home energy consumption by 25%) requires finding an optimal combination of house shell components like windows, walls, roofs, insulation and mechanical equipment. There are millions of possible ways to design and build each house, and each can greatly affect cost, energy consumption and comfort. Unfortunately, architects and builders are not aware of all these combinations and don't have the tools and skills to find the best one. Thus, their selection is based on past experience and preference and usually yields suboptimal results. In most cases, homeowners can achieve better energy results for their investment or reach their energy-related goals for a much lower cost.

Systems and methods exist in which a user can try to identify the best building materials for green building. The existing solutions to try to build energy efficient buildings are too expensive and give only partial support. The existing solutions may include an architect's experience, an architect hiring an energy analysis using energy analysis software, an architect using third party energy analysis and/or a homeowner using an on-line retrofit analysis software. Each of those existing solutions, the cost can be as much as $50,000 and has many limitations. For example, none of these tools offers quick design data capture, automatic optimization capabilities, full cost/benefit analysis, early design optimization (such as, house orientation and shape) or easy visualization, and they all have a very steep learning curve. Thus, architects and builders usually use a combination of in-house developed spreadsheets and gut feelings to identify and suggest a possible design to their clients and then hire an expert to validate their findings. This process is time consuming and does not provide the optimization analysis for finding best designs. The existing solutions also usually cannot answer the questions:
If I had $1,000 more to invest in energy systems, what would I do?
What is the most cost effective way for me to meet energy codes?
How can I best protect myself from future energy cost spikes?

Thus, it is desirable to provide a green building system and method that overcomes the above limitations of the existing solutions and it is to this end that the disclosure is directed.

### BRIEF DESCRIPTION OF THE DRAWINGS

FIG. 1 illustrates an implementation of a client/server architecture of a green building system;

FIG. 2 illustrates an example of the interactions between the users and the system;

FIGS. 3A and 3B are diagrams of a plot chart and a table, respectively of a set of several thousand design choices for the same house generated by the decision engine;

FIG. 4 illustrates a goal seek and design comparison user interface of the system;

FIG. 5 illustrates more details of the decision engine;

FIGS. 6A-6E illustrate examples of building specific dimension information user interfaces of the system;

FIG. 7 illustrates an example of the window choice user interface;

FIG. 8 illustrates an example of the user interface for an architect;

FIG. 9 illustrates low level details of the decision engine;

FIG. 10 illustrates an example of the database schema of the system;

FIG. 11 is an example of a user interface of a incentives feature; and

FIGS. 12A-12B are examples of a user interface of the incentive feature.

### DETAILED DESCRIPTION OF ONE OR MORE EMBODIMENTS

The disclosure is particularly applicable to a client/server based building system design, construction and maintenance and method and it is in this context that the disclosure will be described. It will be appreciated, however, that the system and method has greater utility, such as to other architectures of a building system and method and to other implementations of the building system design, construction and maintenance and method.

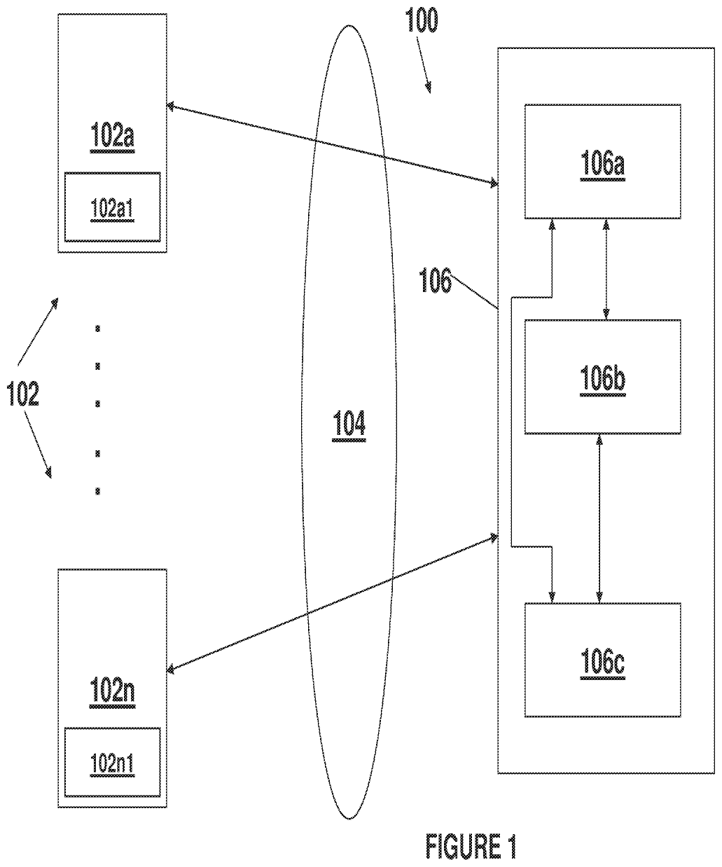

FIG. 1 illustrates an implementation of a client/server architecture of a green building system 100. The system has one or more client computing devices 102 (such as client computing device 102a, . . . , client computing device 102n) that can communicate and connect through a link 104 to a green building unit 106. Each client computing device may be a processing unit based device with sufficient memory, storage capacity, processing power, display capability and connectivity to connect to and interact with the green building unit 106. For example, each client computing device 102 may be SmartPhone device (Apple® product (iPhone, iPad, etc.), RIM® product (Blackberry), Android® OS based devices, etc.), a cellular phone device, a personal computer, a tablet computer and the like. In one implementation, each client computing device 102 may have a typical browser application (102a1, . . . , 102n1 for example for the n client computing devices) that can connect to the green building unit 106 and communicate data and web pages with the green building unit 106. The link 104 may be a wireless or wired link that allows the one or more client computing devices 102 to connect to and interact with the green building unit 106, such as the Internet, a cellular data network, a computer data network and the like. The green building unit 106, in one implementation, may be one or more server computers that execute a plurality of lines of computer code that implement the functions and operations of the green building unit 106. In the client/server architecture implementation, the green building unit 106 may have a web server 106a that interacts with the browser application in each client computing device to exchange data, generate and deliver web pages, generate and deliver web pages with forms, etc., a decision engine 106b and one or more stores 106c that contain the data that is used by the decision engine and the rest of the system to perform the functions and operations described below. In one implementation, the code executed by the green building unit 106 is written in Java and Java Script and each client computing device interacts with the program through a web browser (Firefox, Chrome, IE, Safari). In this implementation, the program is downloaded from the green building unit 106 to the client computing device 102 and runs as a “rich internet application” on the web browser in Java Script and the client computing device communicates with the remote green building unit 106 using standard communication protocols (REST, HTTP, JSON, HTML.) The client initiates the green building process as described below on the one or more server computers and the code for the green building unit 106 is written in Java and runs on Windows, Linux and Unix. In one implementation, the green building process may be written for distributed system allowing to compute millions of permutations on many servers in parallel. By parallel execution, the system allows near-instant computation of different alternatives which is not done today. The green building unit may also have a user interface unit connected to the decision engine that generates the user interfaces of the green building unit as described below.

The system above is a software as a service (SaaS) solution since there is no installation on the client side and that upgrades are handled by the green building unit 106. This allows the system to make easy updates, for example in case we learn that a cost of a window changes. It also allows us to do statistics on our data. For example—In a specific project, the homeowner is charged X for a sqft of wall. Using the system, she can check whether this is the normal price for that type of wall using the summarized analysis of the data in the database. There are other ways to implement the system that may include: 1) a full/partial installation on the client side to give full control of data; 2) a semi manual process—where the optimization is given as a service. The user sends the inputs and someone else running the system is doing the analysis; and 3) a full manual process—User sends one house design and gets back the utility value for that design. If it does not pass the threshold—the user updates the design and send the updated design for evaluation. The green building system may also be implemented with a piece of software downloaded to each client computer (or delivered to each client computer on a computer readable medium), in a client/server system and in a cloud system in which the one or more server computers are cloud resources.

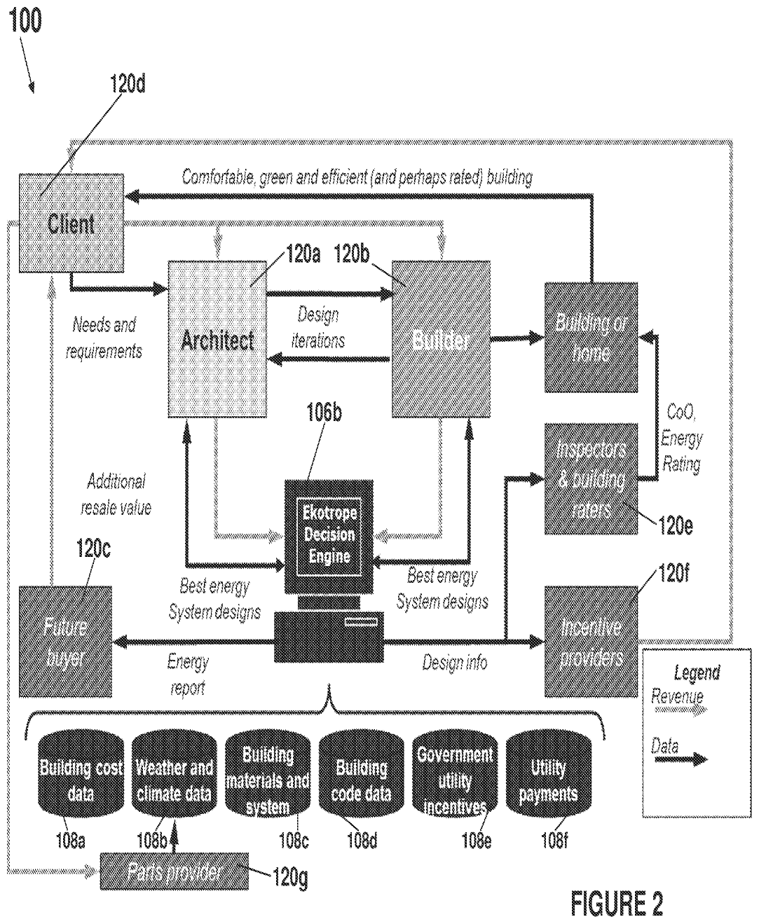

FIG. 2 illustrates an example of the interactions between the users and the system. The decision engine 106b performs an analysis to suggest a best set of building components (for residential, commercial, new or retrofit) to answer the energy needs of the homeowner and the following pieces of data are input to the decision engine 106b:

(a) External data sources:
1. Building component cost data (108a) (for example the cost for different types of windows, walls etc).
2. Weather and climate data (108b) to project the heating/cooling needs at the house location.
3. Building material system (108c)—to verify that we follow the correct building practices.
4. Building code data (108d)—which codes are needed, where and how to check whether a design meets code.
5. Government & utility incentives (108e) and tax breaks (some is location based).
6. Utility payment (cost) (108f)—location based.

(b) Internal data (most data is obtained from the homeowner):
1. Building Specific dimension information—sqft, number of floors, size of windows etc.
2. List of potential components that the client is considering for the house. For example windows types etc., walls, insulation, roof etc. Each input contains the thermal performance of the element and the element cost.
3. Client's special constraints and preferences: Components already chosen, financial constraints, desired payback period etc.
4. Other related information about weather, energy cost etc. needed for estimating the energy needs and costs.

The decision engine 106b establishes a utility function per client which is a combination of desires, financials, environmental awareness and code requirements, calculates all possible design permutations for the house based on a set of design components defined by the client (for example—4 types of potential windows, 5 types of potential walls . . . ); and/or finds the designs that best comply with the utility function.

An Architect/builder 120a, 120b uses the analysis from the decision engine 106b to compare and choose a design for the house (windows, walls, roof etc.), communicate the different design options as well as their utility (cost, benefit) and tradeoff to the home owner 120d (called client on the diagram), provide the needed “proof” to inspector 120e (for getting building, occupancy permit in case proof of environmental analysis is needed), and incentive providers 120f and compare design tradeoffs during construction (for example if a certain insulation is not available).

The system may have an input for the parts provider 120g who can enter information about new components available (for example new type of window) into the system. This will allow homeowners (clients) wider variety to choose from and will increase exposure for the parts provider. Future buyers 120c get information about energy consumption of a house (e.g., energy report) they are considering buying and in return willing to pay more for the house. Mortgage providers get information about energy consumption of a future house and, in return, they give a better mortgage terms (fewer risk of default due to smaller utility bills).

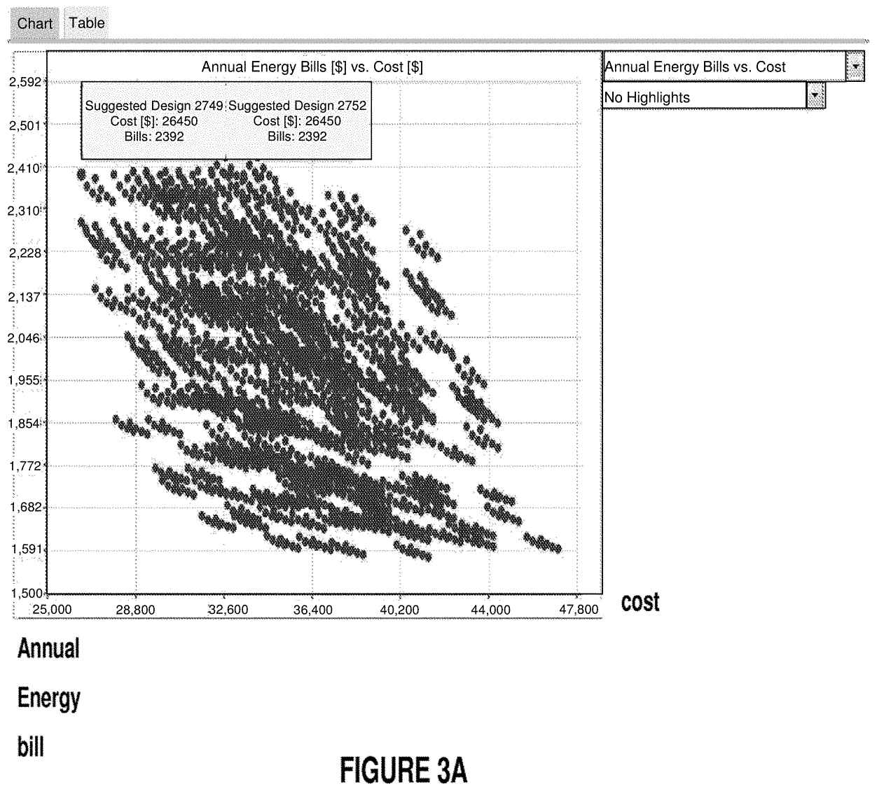

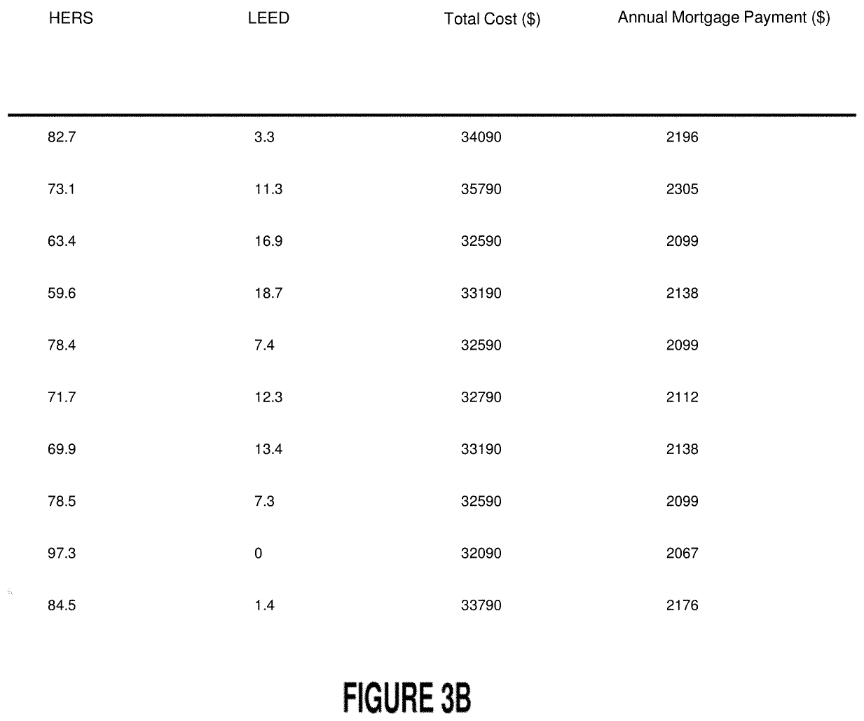

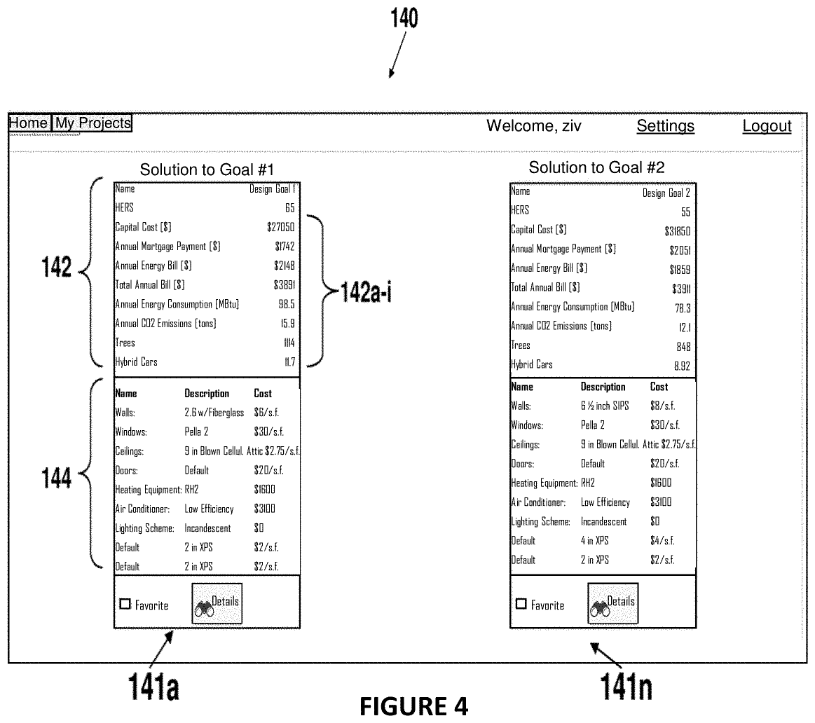

FIGS. 3A and 3B are illustrations of a plot chart and a table of the design choice generated by the decision engine 106b in which each design is a point in the chart in FIG. 3A. In these figures that trade-off between annual energy bills and cost are shown for different design choices. FIG. 4 illustrates a goal seek user interface 140 of the system in which goal seeks—design tradeoffs between several designs are illustrated to the user. For example, as shown in FIG. 4, a first design solution 141a and a second design solution 141n that match the various inputs and filters are displayed to the user. Each design solution 141 may include a calculated design results portion 142 that shows calculated values for the particular design solution and a design parameters portion 144 that lists the various design choices (lighting, air conditioner, etc.) that are part of each design solution. The calculated design results portion 142 may further include an HERS value for the design solution, a capital cost of the design solution, an estimated annual mortgage payment for the design solution, an estimated annual energy bill for the design solution, an estimated annual energy consumption for the design solution, an estimated annual CO2 emissions of the design solution, an estimated number of trees planted based on the reduced CO2 emissions and/or an estimated number of cars converted into hybrid cars that would correspond to the CO2 reduced emissions (142a-142i).

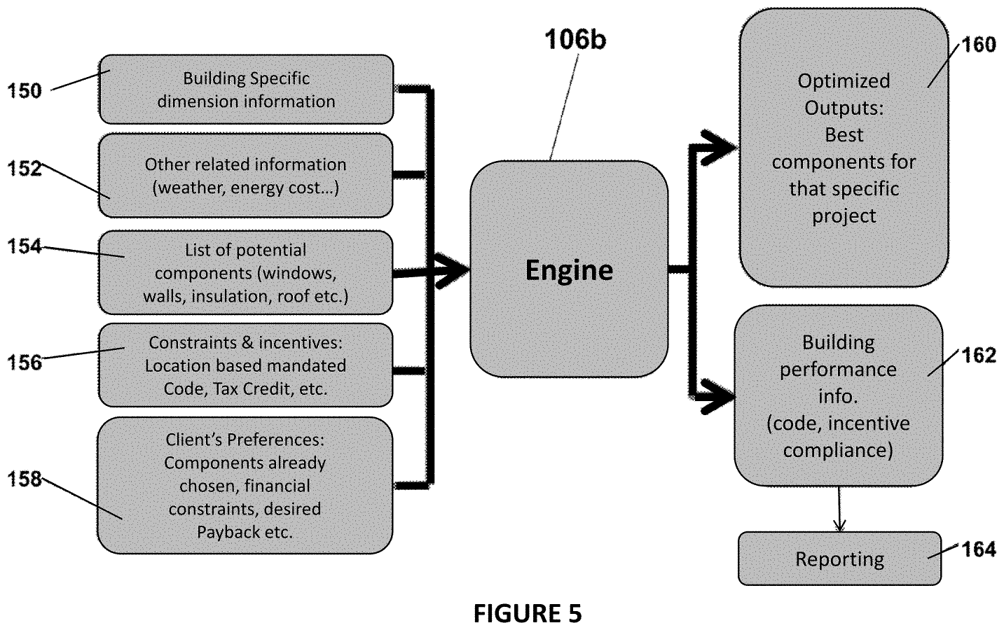

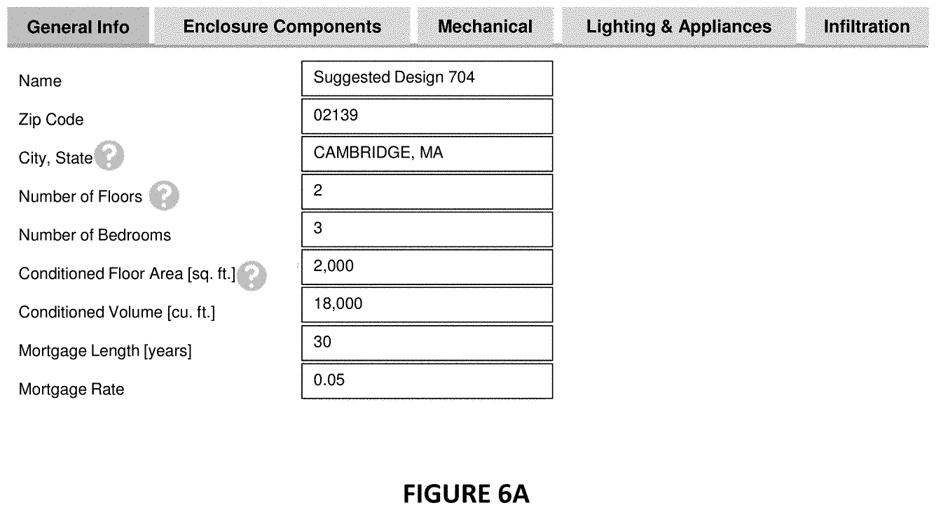

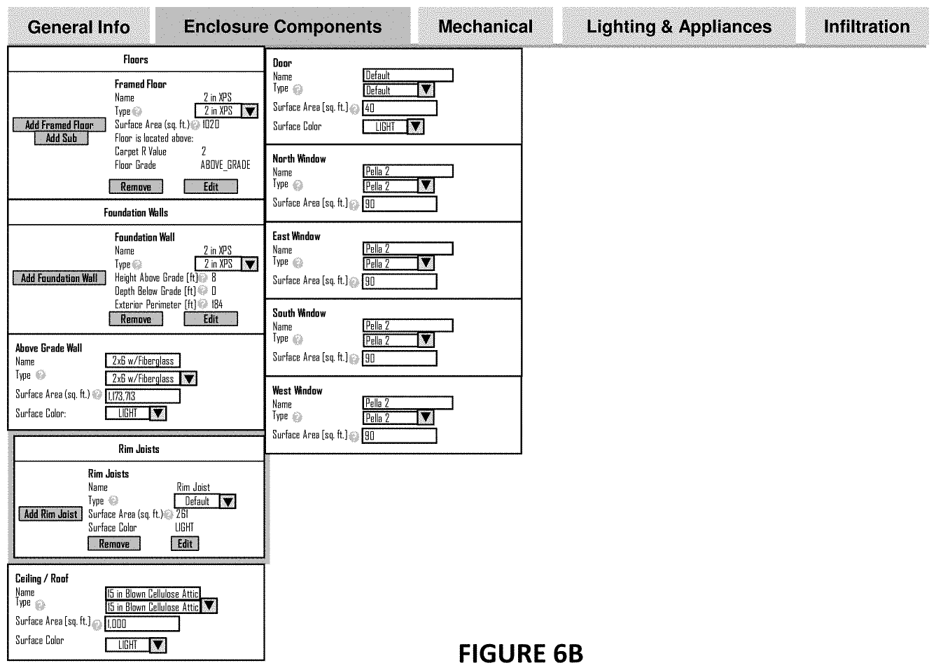

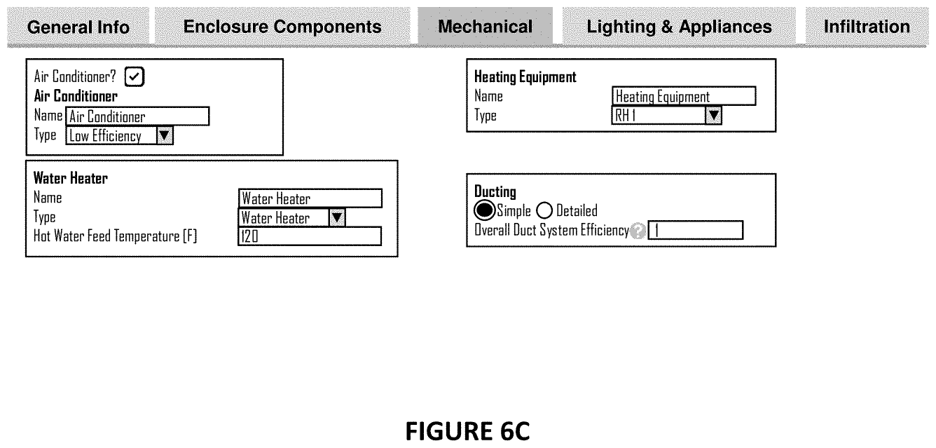

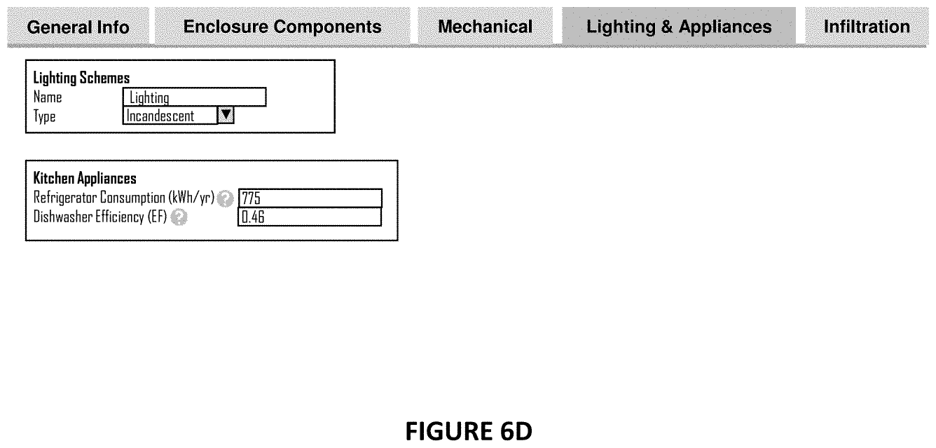

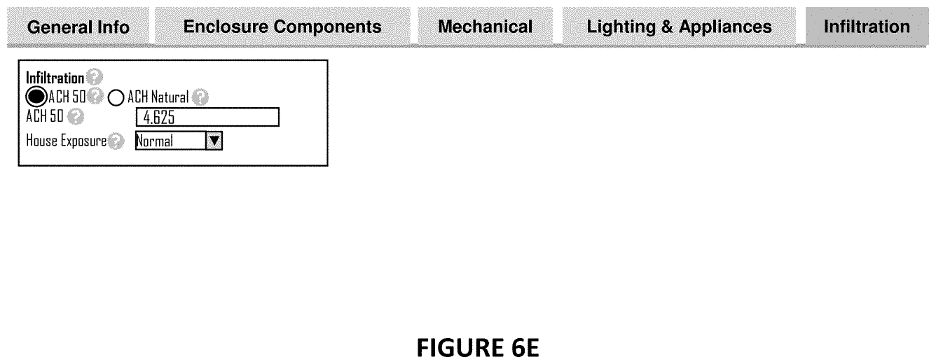

FIG. 5 illustrates more details of the decision engine 106b. The inputs to the decision engine 106b may include Building Specific Dimension information 150 (an example user interface of which is shown in FIG. 6A) which is the information needed about the size, orientation and type of material and components that the architect/builder plans to use for the house and are needed for the energy analysis.

Another input to the decision engine 106b may be other related information 152 which are other inputs needed for running the analysis that may include: building component cost data; Weather and climate data to project the heating/cooling needs at the house location; Building material; Building code data; Government & utility incentives and tax breaks (some are location based); and Utility payment (cost) which can be location based.

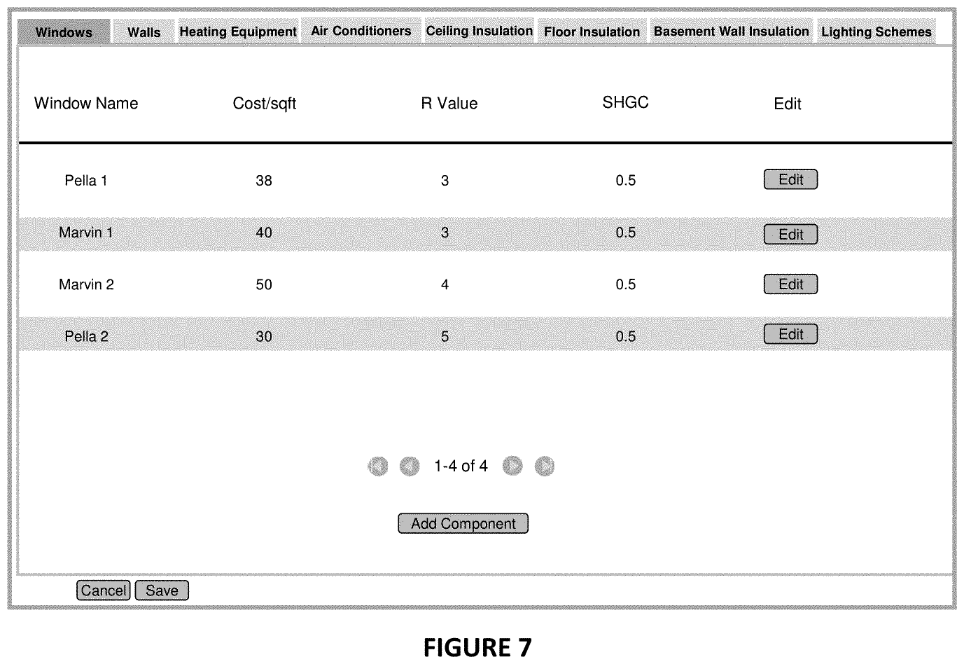

The inputs may also include a list of potential components 154 which includes user input of possible selection of enclosure/wall components (see FIG. 6B that has an example of the user interface for the enclosure/wall components), mechanical components (see FIG. 6C that has an example of the user interface for the mechanical components), windows, heating equipment, air conditioners, ceiling insulation, floor insulation, basement wall insulation, lighting scheme (see FIG. 6D that has an example of the user interface for the lighting components), and infiltration components (see FIG. 6E that has an example of the user interface for the infiltration components.) For example, the user can indicate that she is considering 4 types of windows for the house as shown in FIG. 7.

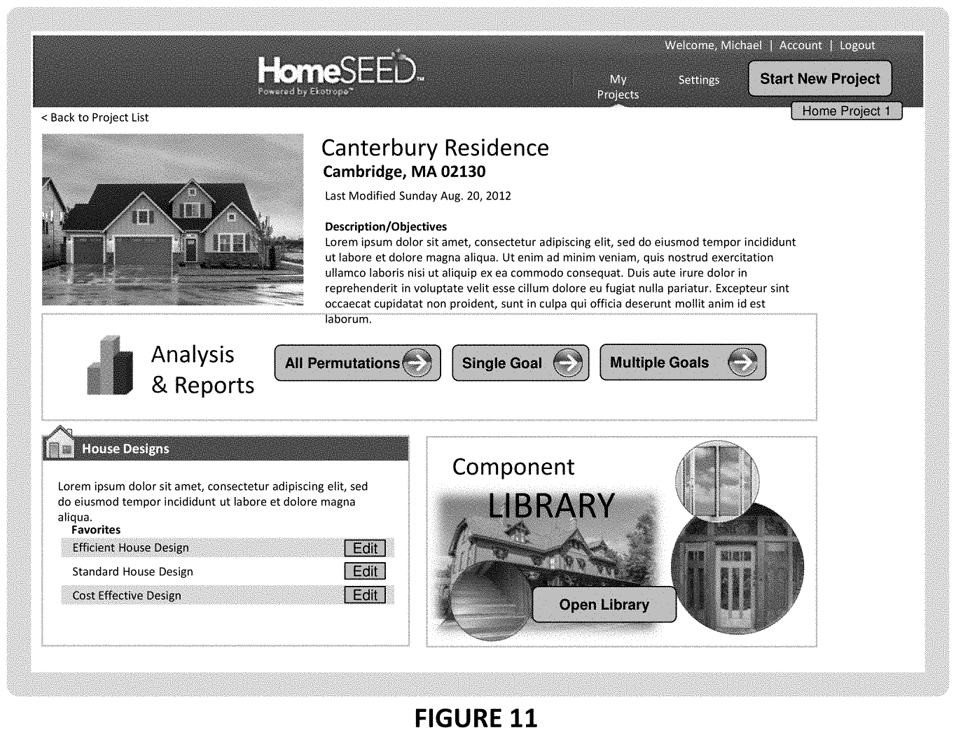

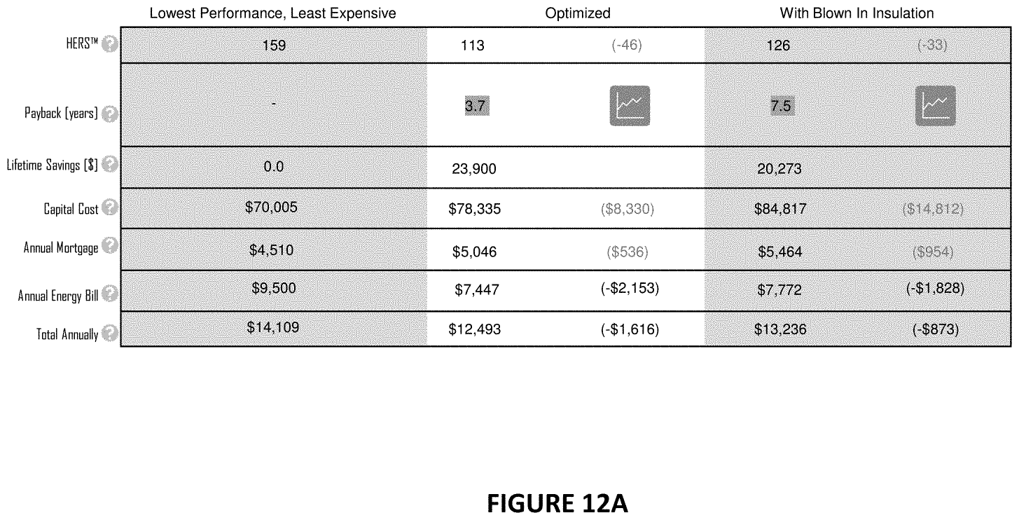

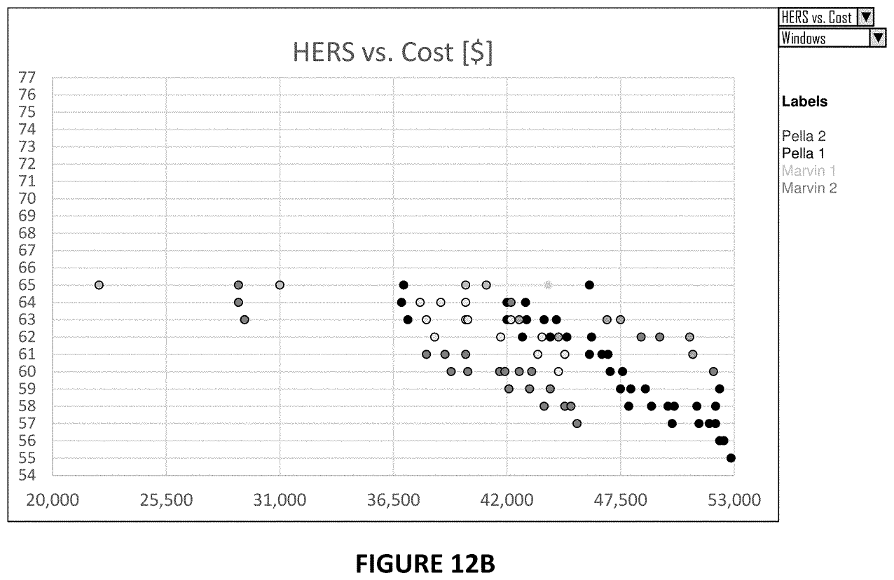

The decision engine may also receive constraints & Incentives 156 which are a list of filters and financial inputs. This list might be location, house size and geometry or time based. For example—a certain building code mandated in a certain town or the potential to get a tax break if meeting a certain energy standard. An example of the user interface for this feature is shown in FIGS. 11-12B. In particular, FIG. 11 is an example of a first user interface screen for the constraints and incentives feature. FIG. 12A illustrates an example of the user interface with some constraints and incentives used by the system and FIG. 12B illustrates an example of a graph that compares HERS to cost.

The decision engine may also receive client's preferences 158 and these can contain filters (for example: I am only interested in window X out of all the possible options) and/or utility function defined by the homeowner. The preferences may also include components already selected by the user, financial constraints and desired payback.

The decision engine may include the processes of: data entry regarding the house geometry, climate and energy related usage; possible option input by user; user defines a utility function; and the system presents the best design. In the first data entry process, the data entry regarding the house geometry, climate and energy related usage is performed. The architect/builder/homeowner can enter the entire data herself or ask the system to “fill-in” the gaps using a smart algorithm that can, for example, fill in the climate info based on ZIP code or “guess” the house shape. The system uses that to promote an “onion” approach where the use can start using the system very early, entering few inputs and add more inputs throughout the design process to replace the automatic algorithm and produce better analysis.

During the possible options definition process, the user adds information regarding possible options for the different components (walls, windows, heating equipment, air conditioners, ceiling insulation, floor insulation, basement wall insulation, lighting scheme, photovoltaic (PV), etc.). During the utility function definition, the user defines a utility function. For example—finding the cheapest design that meets a LEED score of X. The utility function can be one goal, a set of weighted goals that include cost, desired payback, environmental goals, convenience etc. (For example, a utility function can be defined as a sum of 20% upfront cost reduction, 30% payback period reduction, 50% CO₂ emission reduction) or a combination of must meet and weighted nice to have goals. An example of a must meet goal—mandatory environmental code in a certain location.

The engine 106b may have an optimized output portion 160 that generates a list of the best components (enclosure, lighting, etc.) for a specific project based on the various input data. The engine 106b may also have a building performance information portion 162 that generates information about code compliance and incentive compliance for the specific design solution. The engine 106b also has a reporting unit 164 that generates various reports for different users of the system based on the inputs and processes.

Based on the above processes, the system finds and presents to the user the best design for the defined utility function (if the user is looking for one design) or a set of designs that meet criteria (if the user is interested in comparing several options). The process creates all possible design combinations that include all of the combinations of the components defined by the user above. The system also calculates the utility function for each design in which the utility function can be a combination of cost, projected energy consumption, payback period, code compliance etc. The system organizes the solutions according to their utility function score and filters out the design that do not meet the user thresholds (in case filters were defined). The system presents the ordered list to the user. Note: For easy understanding and alternative comparison, the system offers a translation of the results to a more easy to understand metrics that will allow the user to grasp the alternatives. For example—tons CO2 are translated into # of planted trees or converting regular cars to hybrid cars needed to offset the building environmental impact.

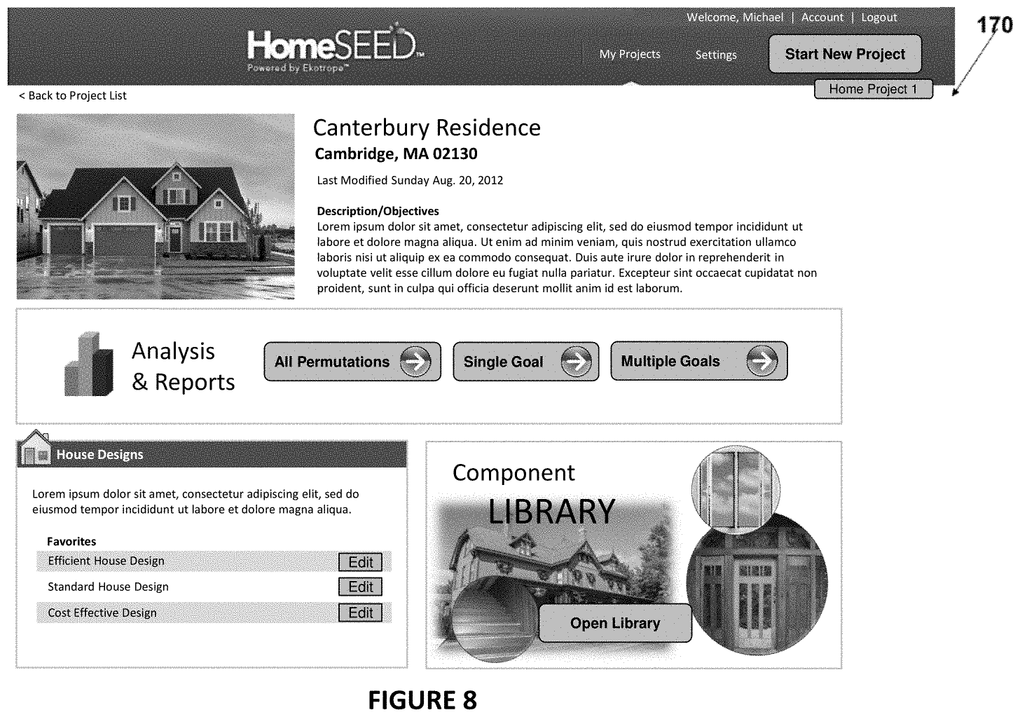

FIG. 8 illustrates an example of the user interface 170 for an architect. The system may also have a user interface for the builder, a home rater (energy analyst), a homeowner, HVAC engineer, parts provider (such as Pella windows, Home Depot etc.) and/or any other stakeholder in the design, construction and maintenance of houses. Each of the different user interfaces present different information to each possible user of the system since each user often has different goals for the system.

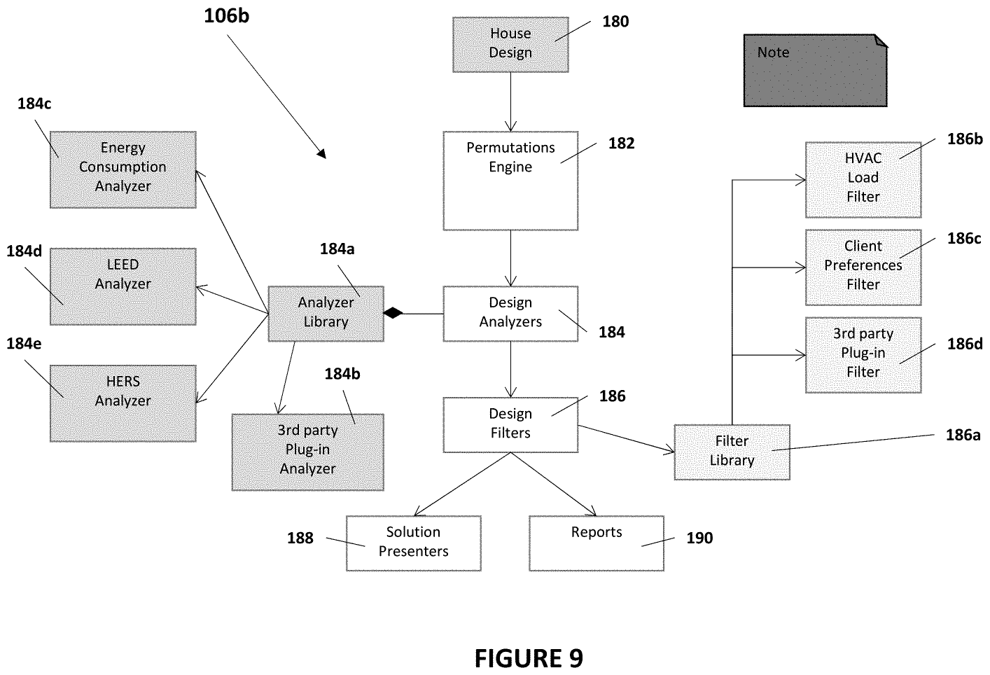

FIG. 9 illustrates low level details of the decision engine 106b. The system provides an expandable/plugin computation for energy decisions. The general flow of the method is as follows:
User defines house design (180).
   The house design can include one or more of the following items:
      House geometry
      Geographical Location
      Financial information (mortgage rate, length, etc.)
      HVAC systems
User defines goals, preferences and restrictions
   Max budget
   Energy goals
   Allowed/desired house components:
      What type of windows to use? What type of doors?
      User can use Ekotrope provided suggestions and/or add his/her own components.
   User specifies what elements should be considered for analysis.
      All elements?
      Just analyze window sizes?
      HVAC?
      Any combination of components.
The user's input is then sent to the system for analysis.
   System can compute/analyze based on complete or partial user information. Defaults will be provided for missing data if allowed.
After receiving user information, the system creates all possible combinations of house designs (permutations by a permutation engine 182) by matching initial user input with possible components and design changes.
All house designs are then analyzed using the system's defined analyzers (184) from an analyzer library 184a stored in the stores 106c.
   Analyzers can include Ekotrope analyzers and/or analyzers provided by 3^{rd} party vendors (184b).
   Analysis provides additional information to each house design such as energy consumption (184c), energy costs, HERS (184d), LEED (184e), etc.
   The system incorporates a cost engine that allows comparisons of CAPEX (cost to build) and OPEX (utility costs.)
   The system also permits full parametric analysis and any design parameter can be optimized on the fly.
   The system also may allow early analysis which means that users do not have to wait until late in the design process to do an energy analysis.
All house designs are sent to the filtering system (186) that has a filter library 186a.
   The filtering system filters out invalid designs and/or designs that do not match the user preferences. An invalid design may be, for example, if the design exceeds capital cost, desired energy usage or payback economics.
   The filtering process may include third party filters 186d, client preference filters 186c and HVAC loading filters 186b, for example.
Filtered set of house designs is presented to the user (188, 190). User can choose from a library of reports or view interactive information regarding the provided house designs.

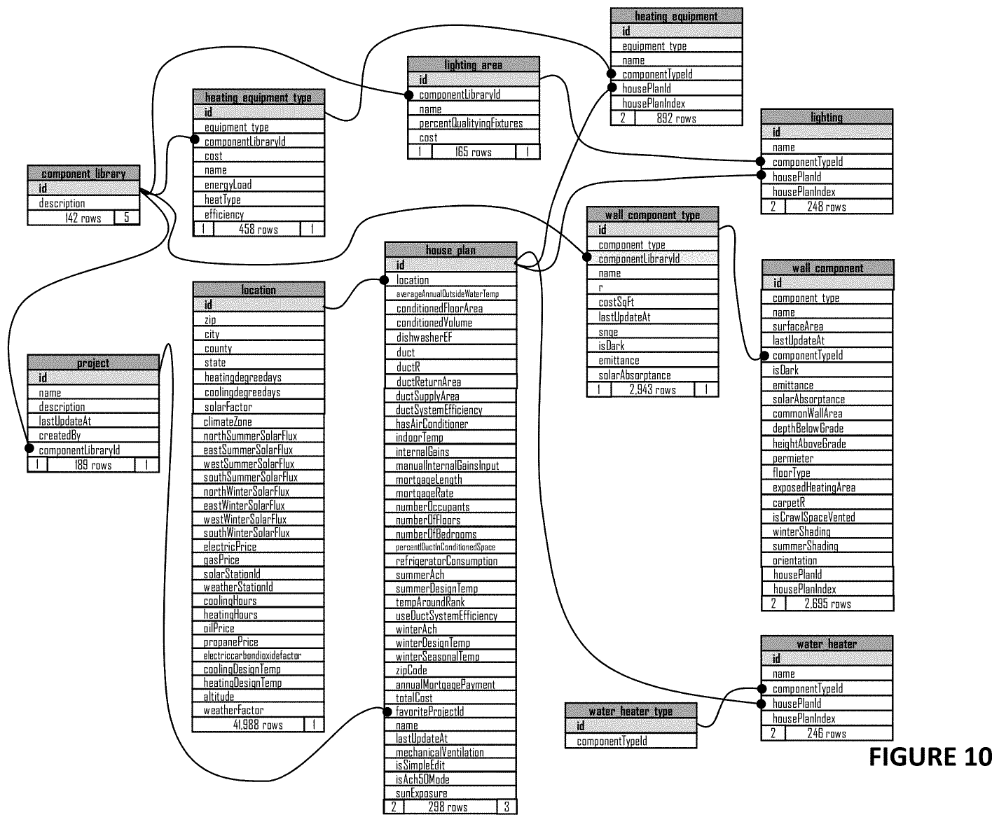

FIG. 10 illustrates an example of the database schema of the system. Since most of the engine executes with in-memory data distributed over multiple servers, the database design is used to define configuration information prior to analysis.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A green building design determining system, comprising:
a computer-implemented green building unit;
one or more client computing devices, each client computing device having a processor and memory and being capable of connecting to the green building unit over a link; and
the green building unit having a decision engine that receives a set of building related inputs for a building project, determines each design that meets the set of building related inputs and generates one or more designs for the building project that comply with a utility function associated with the particular building project, wherein the utility function incorporates a green building parameter.

2. The system of claim 1, wherein the decision engine generates one or more recommended building components for the building project based on the set of building related inputs and generates a set of building performance information based on the set of building related inputs and the one or more recommended building components for the building project.

3. The system of claim 1, wherein the decision engine organizes the one or more designs according to a score of the utility function.

4. The system of claim 1, wherein the green building unit further comprises a user interface unit that generates a user interface with the one or more designs for the building project, wherein the user interface of each design has a calculated design portion that displays calculated values for the design and a design parameter portion that displays the building component choices for the design.

5. The system of claim 2, wherein each building component is one of a wall, a window, a ceiling, a door, heating equipment, an air conditioner and a lighting scheme.

6. The system of claim 1, wherein the set of building related inputs further comprises one or more external data sources and one or more internal piece of data.

7. The system of claim 6, wherein each of the one or more external data sources is one of a building component cost, weather and climate data, building materials, building code, incentives and utility payments.

8. The system of claim 6, wherein each of the one or more internal pieces of data is building specific dimension information, a list of potential building components and a client preference.

9. The system of claim 1, wherein each client computing device executes a browser application on the processor to interact with green building unit.

10. The system of claim 1, wherein the link is one of wireless and wired.

11. The system of claim 1, wherein each client computing device is a smartphone device, a cellular phone device, a personal computer and a tablet computer.

12. The system of claim 1, wherein the green building unit further comprises a plurality of distributed computers that perform determining each design that meets the set of building related inputs.

13. The system of claim 1 further comprising a client application that is downloaded to each client computing device to interact with the green building unit.

14. A computer implemented green building design determining method using a computer-implemented green building unit and one or more client computing devices, each client computing device having a processor and memory and being capable of connecting to the green building unit over a link, the method comprising:
receiving a set of user parameters for a building project of the user;
analyzing, by a computer implemented green building unit, the set of user parameters for the building project of the user to generate one or more designs that match the set of user parameters for the building project of the user;
analyzing, using a set of analyzers that are part of the green building unit, the one or more designs to generate a set of calculated values for each design;
filtering, using a filtering system that is part of the computer implemented green building unit, out one of invalid designs and designs that do not match a preference of the user which is part of the set of user parameters to generate a set of final designs; and
presenting the set of final designs to the user.

15. The method of claim 14, wherein receiving the set of user parameters further comprising receiving a user building design.

16. The method of claim 15, wherein receiving the user building design further comprises receiving one or more of a building geometry, a geographic location of the building, financial information about the building and a HVAC system for the building.

17. The method of claim 14, wherein receiving the set of user parameters further comprising receiving one or more user preferences.

18. The method of claim 17, wherein each of the one or more user preferences is one of a maximum budget for the building project, an energy goal of the building project and a set of desired building components for the building project.

19. The method of claim 14 further comprising generating, by the decision engine, one or more recommended building components for the building project based on the set of user parameters and generating a set of building performance information based on the set of user parameters and the one or more recommended building components for the building project.

20. The method of claim 14, wherein presenting the final designs further comprises organizing the final designs according to a score of the utility function.

21. The method of claim 14, wherein presenting the final designs further comprises generating a user interface with the one or more final designs for the building project, wherein the user interface of each design has a calculated design portion that displays calculated values for the design and a design parameter portion that displays the building component choices for the design.
